(19) United States
(12) Patent Application Publication
(10) Pub. No.: US 2026/0159024 A1
(43) Pub. Date: Jun. 11, 2026

(54) SEAT BELT DETECTION SYSTEM

(71) Applicant: FCA US LLC, Auburn Hills, MI (US)

(72) Inventor: Sarath Chander CB, Chennai (IN)

(21) Appl. No.: 18/973,172

(22) Filed: Dec. 9, 2024

(51) Int. Cl. B60R 22/48

(52) U.S. Cl. CPC B60R 22/48; B60R 2022/4816; B60R 2022/485; B60R 2022/4866

(57) ABSTRACT

A seat belt detection system includes a seat belt assembly having a buckle, a seat belt and a latch member connected to the seat belt and adapted to be releasably retained by the buckle, wherein the seat belt includes a detection portion, and a seat belt detector. The seat belt detector has a first state and a second state and responsive to change from the first state to the second state in the presence of the detection portion within a working range of the seat belt detector.

### FIELD

The present disclosure relates to a system to detect occupant use of a seat belt.

### BACKGROUND

Seat belts are common in passenger vehicles. Some vehicles include seat belt reminder systems that cause an audible alert or chime when a seat belt is not fastened relative to a seat that is determined to be occupied. To avoid the seat belt reminder, some people fasten the seat belt before they sit in the seat, such that the seat belt is between the occupant and the seat, and is not properly in position around the occupant. Because the seat belt is fastened to a buckle of the seat belt assembly, the seat belt reminder does not cause the audible alert to be provided.

### SUMMARY

In at least some implementations, a seat belt detection system includes a seat belt assembly having a buckle, a seat belt and a latch member connected to the seat belt and adapted to be releasably retained by the buckle, wherein the seat belt includes a detection portion, and a seat belt detector. The seat belt detector has a first state and a second state and responsive to change from the first state to the second state in the presence of the detection portion within a working range of the seat belt detector.

In at least some implementations, the seat belt detector includes a sensor or switch having a magnet or a magnetically responsive element, and wherein the detection portion includes or is defined by one or more magnets or a magnetic material. In at least some implementations, the switch includes a magnet that moves when the detection portion is close enough to the magnet such that the magnetic field causes movement of the magnet.

In at least some implementations, a seat belt reminder system is arranged to provide an alert to an occupant of a seat including the seat belt assembly when the latch is determined to be connected to the buckle and the seat belt detector is in the second state. In at least some implementations, the seat belt reminder system is adapted to cause one or more of an audible alert, visible alert or tactile alert to be provided to the occupant.

In at least some implementations, the seat belt assembly is a shoulder belt system in which a portion of the seat belt is adapted to be received over part of an upper torso of an occupant of a seat associated with the seat belt assembly and the detection portion is arranged in said portion of the seat belt.

In at least some implementations, a portion of the seat belt is adapted to be received over a waist of an occupant of a seat associated with the seat belt assembly and the detection portion is arranged in said portion of the seat belt.

In at least some implementations, a vehicle seat has a seat bottom with an occupant facing surface and an opposite lower surface, and a seat back extending upwardly from the seat bottom and including an occupant facing surface and an opposite surface, and the seat belt detector is carried by one or both of the seat bottom and the seat back between the occupant facing surface of the seat bottom and the lower surface, or between the occupant facing surface of the seat back and the opposite surface.

In at least some implementations, the seat belt detector has a magnetically responsive element, when the magnetically responsive element is in a first position the seat belt detector is in the first state, and when the magnetically responsive element is in a second position the seat belt detector is in the second state. In at least some implementations, the magnetically responsive element is part of a switch arranged so that the magnetically responsive element moves when a magnet or magnetic material is close enough to the magnetically responsive element such that a magnetic field causes movement of the magnetically responsive element.

In at least some implementations, a seat belt assembly has a buckle, a seat belt and a latch member connected to the seat belt and adapted to be releasably retained by the buckle, and the seat belt includes a detection portion that is within a working range of the seat belt detector when the latch member is connected to the buckle and the seat belt is not received over an occupant located on the seat bottom.

In at least some implementations, a method of determining an improper use of a seat belt includes detecting that a latch member of a seat belt is connected to a buckle, detecting presence of a portion of the seat belt within a working range of a seat belt detector, and providing an alert when both the latch member is detected to be connected to the buckle and the portion of the seat belt is detected in the working range of the seat belt detector.

In at least some implementations, the detector portion of the seat belt includes one or both of a magnet and a magnetic material, and the seat belt detector includes one or both of a magnet and a magnetically responsive material.

In at least some implementations, the seat belt detector has a magnetically responsive element, when the magnetically responsive element is in a first position the seat belt detector is in the first state, and when the magnetically responsive element is in a second position the seat belt detector is in the second state.

In at least some implementations, the magnetically responsive element is in the first position when the portion of the seat belt is not within the working range of the seat belt detector, and the magnetically responsive element is in the second position when the portion of the seat belt is within the working range of the seat belt detector.

In at least some implementations, the alert is provided as an audible output, a visible output or a tactile output.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 a perspective view of a vehicle seat and seat belt assembly;

FIG. 2 is a diagrammatic view showing a vehicle occupant sitting in a vehicle seat and with a seat belt in a proper position about the occupant;

FIG. 3 is a view similar to FIG. 2 showing the seat belt in an improper position;

FIG. 4 is a fragmentary view showing the seat belt in the improper position with the seat belt latch member connected to a buckle;

FIG. 5 is a schematic view of a normally open switch in an open position;

FIG. 6 is a schematic view of the switch in a closed position due to presence of a seat belt within an operating range of the switch; and

FIG. 7 is a flowchart of a method for determining improper seat belt use.

### DETAILED DESCRIPTION

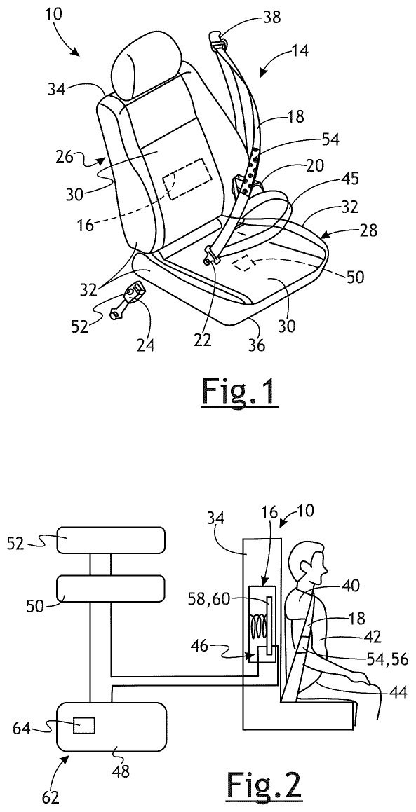

Referring in more detail to the drawings, FIG. 1 illustrates a vehicle seat 10 including a seat belt assembly 14 associated with the seat 10, and a seat belt detector 16 carried by otherwise connected to the seat 10. The seat belt assembly 14 includes a webbing or belt 18 that is spooled about a retractor 20 and has a latch member 22 (e.g. a latch plate 22) that is releasably connectable to a buckle 24. The belt 18 has a disconnected position, as shown in FIG. 1, in which the latch plate 22 is not connected to the buckle 24 and a connected position in which the belt 18 is unwound (i.e. paid out) from the retractor 20, received around over an occupant of the seat 10, and the latch plate 22 is inserted into and connected to the buckle 24.

In the example shown, the seat 10 includes an upright seat back 26 that is positioned behind and extending upwardly relative to a seat bottom 28. The seat back 26 and seat bottom 28 include occupant facing surfaces 30 arranged to be engaged by an occupant sitting/received in the seat 10. The seat back 26 and seat bottom 28 also include side surfaces 32 on opposite sides of the occupant facing surfaces 30, and the seat back 26 includes a rear surface 34 facing away from an occupant in the seat 10, and the seat bottom 28 includes a lower surface 36 facing a floor of the vehicle.

The seat belt assembly 14 is shown as a so-called shoulder belt assembly wherein the seat belt 18 is routed through a guide 38 mounted to the vehicle at a height above the seat bottom 28 and to one side of the seat back 26. So arranged, the seat belt 18 is oriented so that, when in the connected position, such as is shown in FIG. 2, the seat belt 18 is received over the occupant's shoulder 40 and across the occupant's torso 42 to be plugged into the buckle 24 that is located adjacent to the seat bottom 28, on the opposite side of the seat 10 as the retractor 20. The seat belt detector 16 and methods disclosed herein are not limited to use with a shoulder belt assembly, and can be used with different seat belt 18 configurations and arrangements. For example, the seat belt detector 16 and methods can also be used with a so-called lap belt that is not routed through an elevated guide 38 and is instead arranged to loop across the waist 44 of the occupant when connected to the buckle 24 (it is noted that most shoulder belt assemblies have a lap belt portion 45 (FIG. 1) that is received over or near the waist 44 of the occupant).

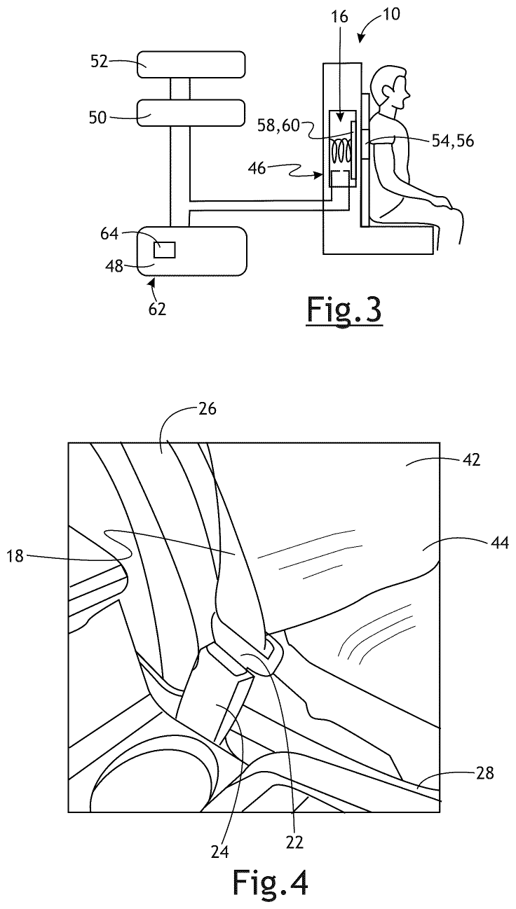

The seat belt detector 16 is diagrammatically shown in FIGS. 2 and 3 and includes a component, such as one or more sensors or switches 46, that is/are responsive to presence of part of the seat belt 18 adjacent to part of an occupant facing surface 30 of the seat 10. By adjacent to the occupant facing surface 30 of the seat 10 it is meant that the relevant part of the seat belt 18 is received between the occupant facing surface 30 of the seat 10 (back and/or bottom) and an associated part of the body of the occupant. The associated part of the body of the occupant may be a backside of the torso 42 or a back side of the waist/hips of the occupant. When the seat belt 18 is positioned properly in use, the associated part of the occupant's body is between the relevant part of the seat belt 18 and the seat 10, such that the relevant part of the seat belt 18 is not adjacent to the seat back 26 or seat bottom 28 and is instead passed over a front side of the occupant.

Further, the seat belt detector 16 has a working range which is a distance from the detector 16 within which the detector 16 is responsive to presence of the seat belt 18. If the relevant part of the seat belt 18 is outside of the working range, which means that it is at a greater distance from the detector 16 than the working range, then the detector 16 cannot sense or determine the presence of the seat belt 18, and this is also considered to be not adjacent to the occupant facing surface 30 of the seat 10.

Many modern vehicles include a seat belt reminder system 48 intended to detect when a seat belt 18 of an occupied seat 10 is not being used with the vehicle is in operation. These systems can detect that an occupant is in a seat 10 with a suitable sensor or switch 50 in the seat 10 that is actuated when an occupant is on the seat 10. And these systems can detect whether the latch plate 22 is connected to a buckle 24 by another buckle sensor or switch 52. Thus, when a seat 10 is determined to be occupied (e.g. based on a state or position of the seat switch 50, or an output signal therefrom) and the latch plate 22 is determined to not be connected to the associated buckle 24 (e.g. based on an output from/state of the buckle switch 52), the seat belt reminder system 48 provides an alert which may be visible or audible, commonly an illuminated icon on a vehicle dashboard/instrument cluster and/or an audible chime.

The alerts are intentionally prominent, and can be annoying to some occupants, with the goal of encouraging the occupant to fasten their seat belt 18 to stop the alert. Some occupants choose to instead fasten the latch plate 22 into the buckle 24 before they sit in the seat 10, such as is shown in FIGS. 3 and 4. Then, when the occupants sit in the seat 10, the seat belt 18 is behind the occupant, between the occupant facing surface(s) 30 of the seat 10 and the occupant. Thus, the occupant is not secured in the seat 10 by the seat belt 18 but, because the latch plate 22 is connected to the buckle 24, no alert is provided from the seat belt reminder system 48.

The seat belt detector 16 is arranged to determine when the seat belt 18 is in an improper position, such as the position shown in FIGS. 3 and 4. As shown in FIGS. 1-3, the seat belt detector 16, in at least some implementations, may be arranged behind part of the occupant facing surface(s) 30 of the seat back 26, at least when a shoulder belt 18 system is provided. The seat belt detector 16 includes a sensor or switch 46 that is responsive to the present of the seat belt 18 adjacent to the detector 16 (e.g. within the working range). In one example, the seat belt 18 includes a detection portion 54 that includes an area of the seat belt 18 that is routed near the seat belt detector 16 when the seat belt 18 is in the improper position. The sensor or switch 46 of the detector 16 is responsive to the presence of the detection portion 54 to change a state of the sensor or switch 46 (e.g. send a signal from a sensor or change from either a closed or open position to the other position in the presence of a magnet). In at least some implementations, the detection portion 54 includes or is defined by one or more magnetically responsive components 56 such as magnets or a magnetic material carried by and that may be fixed to the seat belt 18. The detection portion 54 is carried on and may be part of or integrated into the belt 18, and may be flexible and usable with the remainder of the belt. The detector 16 (e.g. the sensor(s) or switch(es) thereof) are responsive to the magnet(s) and/or magnetic material to change state and provide a corresponding output.

In one example, as shown in FIGS. 2 and 3, the detector 16 includes a switch 46 having a magnetically responsive switch element 58 shown as a magnet 60. In a first position of the magnet 60, shown in FIG. 2, the detection portion 54 of the belt 18 is not within the working range of the magnet 60, and the switch 46 is in a first state, shown as closed in this example. When the detection portion 54 of the seat belt 18 is adjacent to the detector 16, as shown in FIG. 3, the magnet 60 is displaced from the first position to or toward a second position in with the switch 46 is in a second state, shown as open in this example. The detection portion 54 in this example may include a magnet or a magnetic material 56 or both, and is arranged to be attract and cause movement of the magnet 60 within the working range of the detector 16.

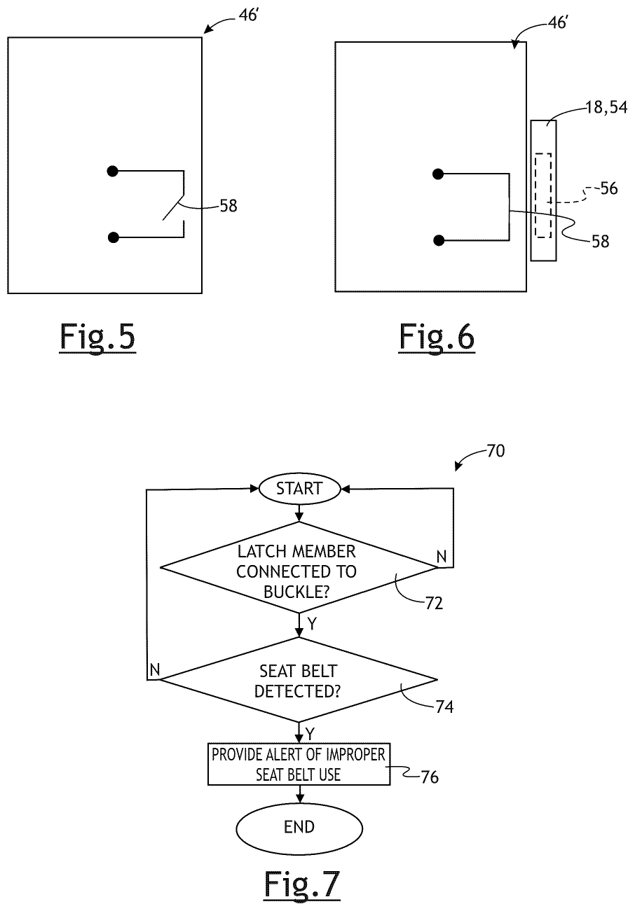

FIGS. 5 and 6 show another example of a detector 16 including a switch 46′ that is normally open (first state, shown in FIG. 5) but in the presence of the detection portion 54 of the seat belt 18, is moved to a closed position (second state, shown in FIG. 6). In this example, the seat belt 18 carries a magnet 56 the field of which moves a magnetically responsive switch element 58, which includes or is defined by a magnetic material (e.g. includes iron) to the closed position when near enough to the switch element 58. Use of a normally open switch could be in an independent circuit or otherwise incorporated to work with the controller and the other switches to work as noted. The magnetic switches or sensors may be so-called “hall-effect” switches or sensors.

While shown with the detector 16 responsive to part of the seat belt 18 that extends across the seat back 26, the detector 16 and detection portion 54 of the seat belt 18 may be arranged to detect part of a lap belt 18, which may be a lap belt 18 portion of a shoulder belt 18 system. Thus, the detector 16 may be lower along the seat back 26 or near or at the seat bottom 28.

The magnetically responsive detector 16 can be actuated without direct contact between the detection portion 54 of the seat belt 18 and the detector 16, in a so-called non-contact sensor or detection arrangement. The magnetic field or fields of the components of the system penetrate the material covering the seat back 26 (and/or seat bottom 28) and act on the detector 16 to cause it to change state. The magnetic field strength and sensitivity or responsiveness of the components can be set to provide a desired operation of the system.

The detector switch or sensor 46 can be part of a circuit 62 include a seat belt reminder system 48 or the like. One or more controllers 64 (e.g. ECUs) may be present in the circuit 62 as with a seat belt reminder system, such as but not limited to, a body control module or infotainment controller or control module. The controller 64 may include or be communicated with one or more processors and memory having instructions or programs for operation of the seat belt reminder system 48 and to provide the feedback from the seat belt detector 16 to an occupant of the seat 10 or vehicle. Thus, when the switch or sensor 46 changes state or otherwise responds to a seat belt 18 near the detector 16, the system may provide an alert to the occupant(s). The alert may be visible, audible or tactile (e.g. vibration output to the seat 10 or the like), such as that described above with regard to seat belt reminder systems used to detect with the seat belt 18 is not connected to the buckle 24. In this way, even if the seat belt 18 is connected to the buckle 24 but is in an improper position behind the occupant, the seat belt 18 alert can be provided to cause the occupant to wear the seat belt 18 properly.

FIG. 7 illustrates a method 70 for providing an alert when a seat belt 18 is improperly used. The method includes, in step 72, detecting that a latch member 22 of a seat belt 18 is connected to a buckle 24. This can be done using a sensor 52 associated with the buckle 24, as is known in seat belt reminder systems 48.

In step 74, the method includes detecting presence of a detection portion 54 of the seat belt 18 within a working range of a seat belt detector 16. This can be done as set forth in this disclosure, for example, by providing a magnetically responsive element 56 (e.g. a magnet or magnetic material) on a portion 54 of the seat belt 18 and as part of the seat belt detector 16. In at least some implementations, the seat belt detector 16 has a magnetically responsive element, and when the magnetically responsive element is in a first position the seat belt detector 16 is in the first state, and when the magnetically responsive element is in a second position the seat belt detector 16 is in the second state. The magnetically responsive element is in the first position when the portion of the seat belt 18 is not within the working range of the seat belt detector 16, and the magnetically responsive element is in the second position when the portion of the seat belt 18 is within the working range of the seat belt detector 16.

Next, in step 76, the method includes providing an alert when both the latch member 22 is detected to be connected to the buckle 24 and the portion of the seat belt 18 is detected in the working range of the seat belt detector 16. The alert is provided as an audible output, a visible output or a tactile output that is noticeable by one or more occupants of the vehicle.

What is claimed is:

1. A seat belt detection system, comprising:
a seat belt assembly having a buckle, a seat belt and a latch member connected to the seat belt and adapted to be releasably retained by the buckle, wherein the seat belt includes a detection portion; and
a seat belt detector having a first state and a second state and responsive to change from the first state to the second state in the presence of the detection portion within a working range of the seat belt detector.

2. The system of claim 1 wherein the seat belt detector includes a sensor or switch having a magnet or a magnetically responsive element, and wherein the detection portion includes or is defined by one or more magnets or a magnetic material.

3. The system of claim 2 wherein the switch includes a magnet that moves when the detection portion is close enough to the magnet such that the magnetic field causes movement of the magnet.

4. The system of claim 1 which also includes a seat belt reminder system arranged to provide an alert to an occupant of a seat including the seat belt assembly when the latch is determined to be connected to the buckle and the seat belt detector is in the second state.

5. The system of claim 4 wherein the seat belt reminder system is adapted to cause one or more of an audible alert, visible alert or tactile alert to be provided to the occupant.

6. The system of claim 1 wherein the seat belt assembly is a shoulder belt system in which a portion of the seat belt is adapted to be received over part of an upper torso of an occupant of a seat associated with the seat belt assembly and the detection portion is arranged in said portion of the seat belt.

7. The system of claim 1 wherein a portion of the seat belt is adapted to be received over a waist of an occupant of a seat associated with the seat belt assembly and the detection portion is arranged in said portion of the seat belt.

8. The system of claim 1 which also includes a vehicle seat having a seat bottom with an occupant facing surface and an opposite lower surface, and a seat back extending upwardly from the seat bottom and including an occupant facing surface and an opposite surface, wherein the seat belt detector is carried by one or both of the seat bottom and the seat back between the occupant facing surface of the seat bottom and the lower surface, or between the occupant facing surface of the seat back and the opposite surface.

9. The system of claim 8 wherein the seat belt detector has a magnetically responsive element, when the magnetically responsive element is in a first position the seat belt detector is in the first state, and when the magnetically responsive element is in a second position the seat belt detector is in the second state.

10. The system of claim 9 wherein the magnetically responsive element is part of a switch arranged so that the magnetically responsive element moves when a magnet or magnetic material is close enough to the magnetically responsive element such that a magnetic field causes movement of the magnetically responsive element.

11. The system of claim 8 which also includes a seat belt assembly having a buckle, a seat belt and a latch member connected to the seat belt and adapted to be releasably retained by the buckle, wherein the seat belt includes a detection portion that is within a working range of the seat belt detector when the latch member is connected to the buckle and the seat belt is not received over an occupant located on the seat bottom.

12. A method of determining an improper use of a seat belt, comprising:
detecting that a latch member of a seat belt is connected to a buckle;
detecting presence of a portion of the seat belt within a working range of a seat belt detector; and
providing an alert when both the latch member is detected to be connected to the buckle and the portion of the seat belt is detected in the working range of the seat belt detector.

13. The method of claim 12 wherein the portion of the seat belt includes one or both of a magnet and a magnetic material, and the seat belt detector includes one or both of a magnet and a magnetically responsive material.

14. The method of claim 13 wherein the seat belt detector has a magnetically responsive element, when the magnetically responsive element is in a first position the seat belt detector is in the first state, and when the magnetically responsive element is in a second position the seat belt detector is in the second state.

15. The method of claim 14 wherein the magnetically responsive element is in the first position when the portion of the seat belt is not within the working range of the seat belt detector, and the magnetically responsive element is in the second position when the portion of the seat belt is within the working range of the seat belt detector.

16. The method of claim 12 wherein the alert is provided as an audible output, a visible output or a tactile output.
